(19) United States
(12) Patent Application Publication
(10) Pub. No.: US 2026/0276307 A1
(43) Pub. Date: Sep. 17, 2026

(54) HEATING SYSTEM AND ANNEALING FURNACE USING SUCH SYSTEM

(71) Applicant: NINGBO SACHSEN INDUSTRIAL TECHNOLOGY CO., LTD., Ningbo (CN)

(72) Inventor: Wanglin ZHENG, Ningbo (CN)

(73) Assignee: NINGBO SACHSEN INDUSTRIAL TECHNOLOGY CO., LTD., Ningbo (CN)

(21) Appl. No.: 19/192,376

(22) Filed: Apr. 29, 2025

(30) Foreign Application Priority Data
Mar. 12, 2025 (CN) 202510285893.7

(51) Int. Cl. F27D 7/04; F04D 17/08; F04D 29/42; F27D 11/00

(52) U.S. Cl. CPC F27D 7/04; F04D 17/08; F04D 29/4226; F27D 11/00; F27D 2007/045

(57) ABSTRACT

A heating system and an annealing furnace, where the heating system includes a fan, an air inlet tube, and a heater. An air inlet direction of the fan is vertically upward, and the air outlet direction is horizontal. The heater is provided with a tangential air inlet in a cylindrical inner housing, where an air flow enters in a tangential direction and spirally flows along an inner wall, and is discharged vertically downward. An air outlet of the fan directly communicates with the air inlet of the heater, without the need to arrange an elbow connecting tube, simplifying a pipeline structure, and reducing pressure loss of the air flow. This present invention simplifies an equipment structure, reduces energy consumption, and enhances the heat exchange effect of the air flow, thus making it suitable for heating equipment such as annealing furnaces.

### CROSS REFERENCE TO RELATED APPLICATION

This application is based upon and claims foreign priority to Chinese Patent Application No. 202510285893.7, filed on Mar. 12, 2025, the entire content of which is incorporated herein by reference.

### TECHNICAL FIELD

This application relates to the field of heating equipment, specifically to a heating system and an annealing furnace.

### BACKGROUND

In an annealing furnace heating system, a fan is typically used to deliver the air flow to a heater for heating, and then the heated air flow is delivered into a furnace body. In the prior art, an elbow connecting tube is usually required between the fan and the heater to change the direction of the air flow, but this structure has problems such as high pressure loss of the air flow, complex structure, and high mounting costs. Therefore, how to provide a heating system with a simplified structure, low pressure loss, and good heat exchange effect has become a technical problem that needs to be resolved by those skilled in the art.

### SUMMARY

This application provides a heating system and an annealing furnace that can simplify a pipeline structure, reduce pressure loss of the air flow, and enhance the heat exchange effect of the heater.

The heating system provided by this application includes:
a fan, including a shell with an air inlet and an air outlet, where an air inlet direction of the shell is perpendicular to an air outlet direction of the shell;
an air inlet tube connected to the air inlet of the shell, where the air inlet direction of the shell is consistent with an axial direction of the air inlet tube; and
a heater, including a cylindrical inner housing, where a heating assembly is disposed in the inner housing, a circumferential wall of the inner housing is provided with an air inlet, a first end of the inner housing is closed, a second end of the inner housing is provided with an air outlet, the air outlet of the shell communicates with the air inlet of the inner housing, an air flow output from the shell enters the inner housing in a tangential direction and spirally flows along an inner wall of the inner housing, and is discharged from the air outlet of the inner housing, an air inlet direction of the inner housing is perpendicular to an air outlet direction of the inner housing, and the air inlet direction of the shell is parallel but opposite to the air outlet direction of the inner housing.

Preferably, the second end of the inner housing is connected to an air outlet housing, and a diameter of the air outlet housing gradually decreases from an air inlet end to an air outlet end.

Preferably, the heating assembly includes several heating rods, and heating portions of the heating rods are located in the inner housing and extend along an axial direction of the inner housing, such that the air flow maintains contact with the heating rods during spiral flowing within the inner housing.

Preferably, the heater further includes an outer housing, the inner housing is disposed in the outer housing, the outer housing includes a second end plate, the first end of the inner housing includes a first end plate, several connecting sleeves are connected between the first end plate and the second end plate to form several through channels between the first end plate and the second end plate, the heating rods are in one-to-one correspondence to the connecting sleeves, each heating rod is fixed to a respective second end plate, and each heating rod runs through a corresponding connecting sleeve to extend into the inner housing.

Preferably, the heating rod is fixed with an annular protrusion, the second end plate is located between the first end plate and the annular protrusion, and the second end plate is further provided with a pressing plate configured to press and fix the annular protrusion against an end surface of the second end plate.

Preferably, a threaded pillar is disposed on the end surface of the second end plate, the pressing plate movably sleeves the threaded pillar, and a nut is threaded onto the threaded pillar to press and fix the pressing plate against an end surface of the heating rod.

Preferably, the fan further includes a driving motor and a bracket, the bracket is disposed on the shell, the driving motor is disposed on the bracket, an extension direction of an output shaft of the driving motor is parallel to the air inlet direction of the shell, and the output shaft of the driving motor drives a fan wheel in the shell to rotate via a transmission mechanism.

The annealing furnace provided by this application includes the heating system.

One or more technical solutions provided in this application have at least the following technical effects or advantages:

The air inlet direction of the fan is vertically upward, and the air outlet direction is horizontal. The air inlet direction of the heater is horizontal and tangential. The air flow spirally flows inside the inner housing, and is discharged vertically downward, to enter the furnace body. Thus, the heater provides a heat exchange function and changes the direction of the air flow, without the need to arrange an elbow connecting tube between the air inlet end of the fan and the air outlet end of the heater to change the direction of the air flow, simplifying the pipeline structure, and reducing air pressure loss. Additionally, the spiral flowing action enhances the heat exchange effect between the air flow and the heater, thereby improving the heat exchange efficiency.

### BRIEF DESCRIPTION OF THE DRAWINGS

FIG. 1 is a schematic structural diagram of a heating system according to an embodiment.

FIG. 2 is a front view of the heating system according to an embodiment.

FIG. 3 is a cross-sectional view taken along line A-A of FIG. 2.

FIG. 4 is a cross-sectional view of the heater.

FIG. 5 is a cross-sectional view of a heater with all heating rods removed.

Description of reference numerals: 10. fan; 11. shell; 12. driving motor; 13. bracket; 20. air inlet tube; 30. heater; 31. inner housing; 311. first end plate; 32. outer housing; 321. second end plate; 322. pressing plate; 323. threaded pillar; 33. air outlet housing; 34. heating rod; and 341. annular protrusion.

### DETAILED DESCRIPTION OF THE EMBODIMENTS

To make the above objectives, features, and advantages of the present invention more apparent and understandable, the following describes specific embodiments of the present invention in detail with reference to the accompanying drawings.

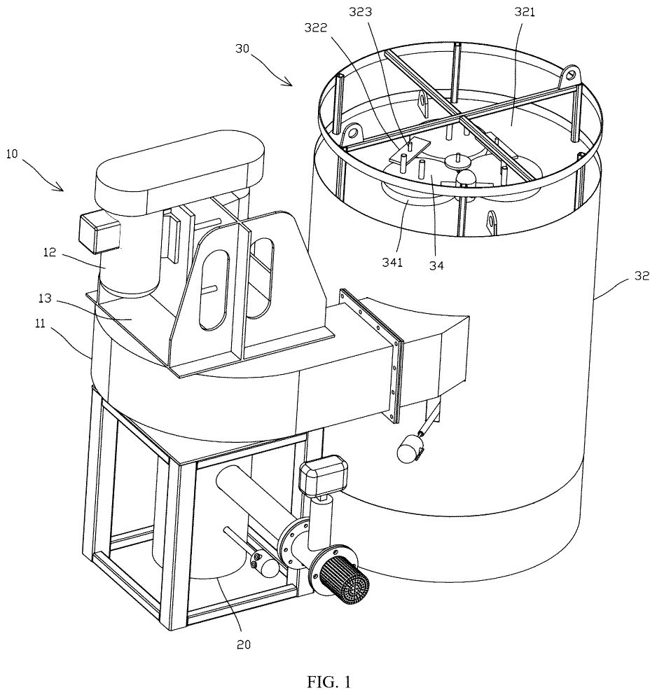

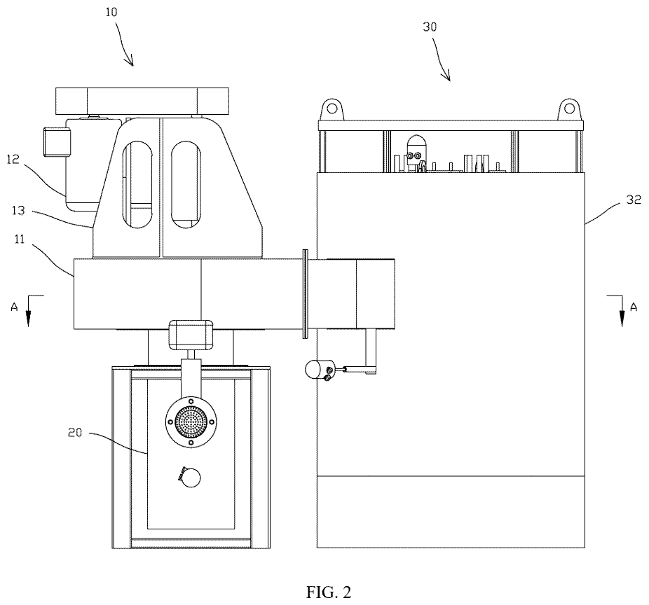

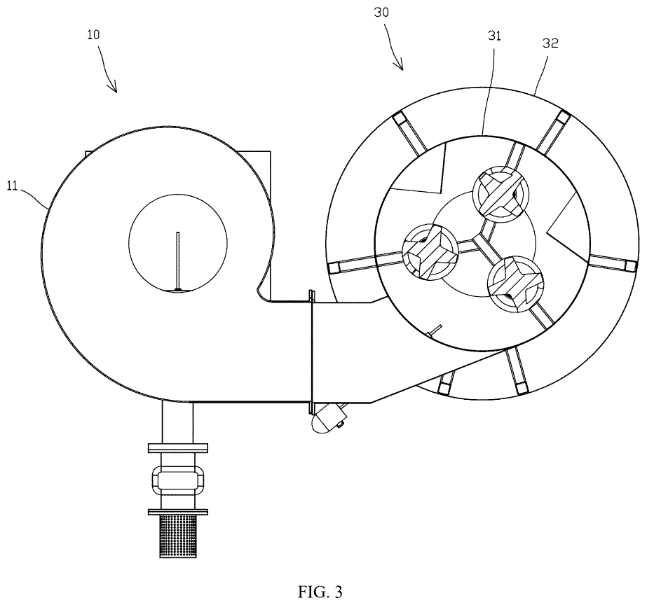

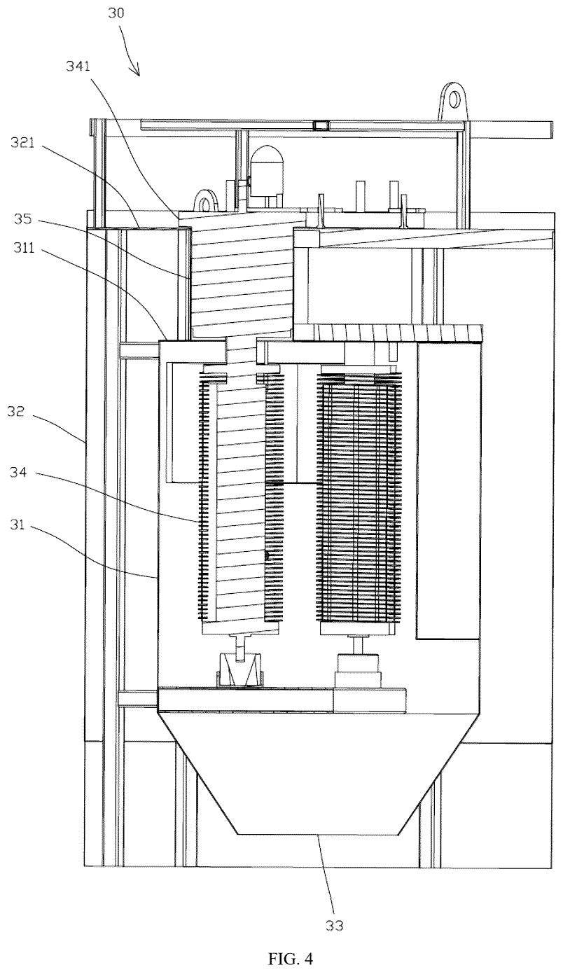

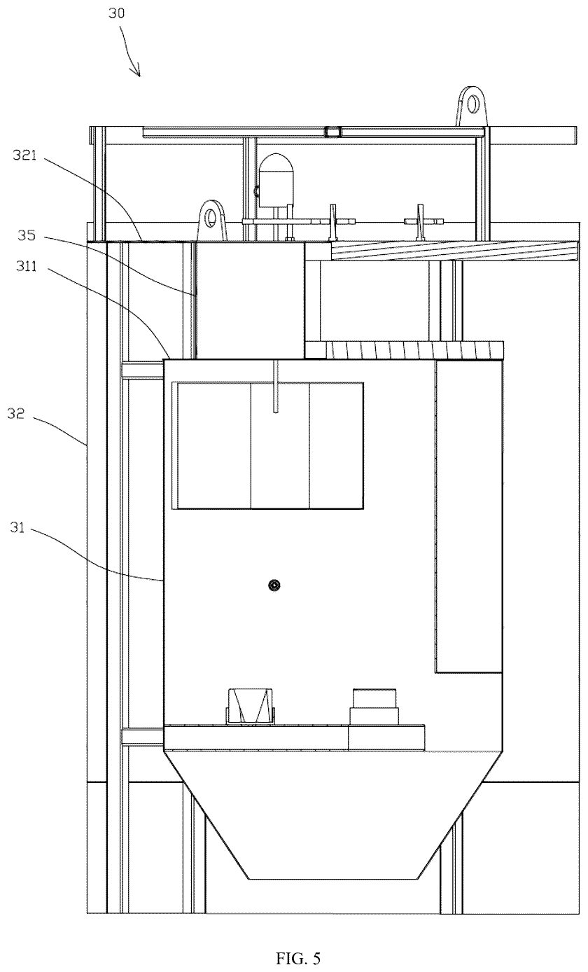

As shown in FIGS. 1 to 5, a heating system of this embodiment includes a fan 10, an air inlet tube 20, and a heater 30.

The fan 10 includes a shell 11, a driving motor 12, and a bracket 13. The bracket 13 is disposed on the shell 11, and the driving motor 12 is disposed on the bracket 13. The shell 11 has an air inlet and an air outlet, and the shell 11 is in the shape of an involute. A fan wheel is disposed inside the shell 11, and the driving motor 12 drives the fan wheel in the shell 11 to rotate via a transmission mechanism to generate an air flow in the shell 11. The air inlet direction of the shell 11 is vertically upward, and the air outlet direction of the shell 11 is horizontal.

The air inlet tube 20 is vertically arranged, and the upper end of the air inlet tube 20 is connected to the air inlet of the shell 11. The air inlet direction of the shell 11 is consistent with the axial direction of the air inlet tube 20.

The heater 30 includes a cylindrical inner housing 31, an outer housing 32, heating rods 34, and connecting sleeves 35. A heating assembly is disposed in the inner housing 31, and a circumferential wall of the inner housing 31 is provided with a tangential air inlet. An upper end of the inner housing 31 is closed, and an air outlet is provided at a lower end of the inner housing 31. The lower end of the inner housing 31 is connected to an air outlet housing 33. An air inlet end of the air outlet housing 33 is connected to the lower end of the inner housing 31. The air outlet housing 33 discharges air vertically downward, and the diameter of the air outlet housing 33 gradually decreases from top to bottom, thereby increasing the exhaust flow rate of the heater 30.

The air outlet of the shell 11 communicates with the air inlet of the inner housing 31. The air flow output from the shell 11 enters the inner housing 31 in a tangential direction and spirally flows along an inner wall of the inner housing 31, and is discharged from the air outlet of the inner housing 31. The air inlet direction of the inner housing 31 is perpendicular to the air outlet direction of the inner housing 31. The air inlet direction of the shell 11 is parallel but opposite to the air outlet direction of the inner housing 31. In other words, the shell 11 has a vertically upward air inlet, and the inner housing 31 has a vertically downward air outlet.

There are multiple heating rods 34, and heating portions of the heating rods 34 are all located in the inner housing 31 and extend along the axial direction of the inner housing 31, such that the air flow maintains contact with the heating rods 34 during spiral flowing within the inner housing 31, thereby improving the heating efficiency of the air flow in the inner housing 31.

There are multiple connecting sleeves 35, and the inner housing 31 is disposed in the outer housing 32. The outer housing 32 is also cylindrical; an upper end of the outer housing 32 is closed and a lower end is open. The upper end of the outer housing 32 has a second end plate 321, and the upper end of the inner housing 31 has a first end plate 311. The first end plate 311 and the second end plate 321 are parallel to each other. Multiple connecting sleeves 35 are connected between the first end plate 311 and the second end plate 321 to form several through channels between the first end plate 311 and the second end plate 321. The heating rods 34 are in one-to-one correspondence to the connecting sleeves 35. An upper end of each heating rod 34 is fixed to the second end plate 321, and each heating rod 34 passes through the corresponding connecting sleeve 35 to extend into the inner housing 31. This structure, by means of setting the multiple heating rods 34, can increase the total number of heating elements, expanding the contact area between the air flow and the heating elements, thereby significantly improving the heat exchange efficiency. In addition, the through channels are formed by the connecting sleeves 35 between the first end plate 311 and the second end plate 321, and the heating rods 34 are fixedly mounted, running through the connecting sleeves 35. This ensures the stable mounting of the heating rods 34 and allows the heating rods 34 to freely extend during thermal expansion, further improving the stability and durability of the heating rods 34.

The heating rod 34 is fixed with an annular protrusion 341. The second end plate 321 is located between the first end plate 311 and the annular protrusion 341, with the annular protrusion 341 located above the second end plate 321. The second end plate 321 is also provided with a pressing plate 322 for pressing and fixing the annular protrusion 341 against the end surface of the second end plate 321.

Specifically, a threaded pillar 323 is disposed on the end surface of the second end plate 321. The pressing plate 322 movably sleeves the threaded pillar 323, and a nut is threaded onto the threaded pillar 323. The nut can move downward by rotating on the threaded pillar 323, thereby pressing and fixing the pressing plate 322 against the end surface of the heating rod 34 via the nut. This structure, through fitting between the annular protrusion 341 and the pressing plate 322, ensures the reliable fixing of the heating rod 34 and facilitates the disassembly and replacement of the heating rod 34, facilitating maintenance and repair of the equipment.

The shell 11 is horizontally arranged, the bracket 13 is mounted on the upper surface of the shell 11, and the driving motor 12 is mounted on the bracket 13. The driving motor 12 is located above the shell 11, and the extension direction of the output shaft of the driving motor 12 is parallel to the air inlet direction of the shell 11. In other words, the output shaft of the driving motor 12 is vertically upward. The output shaft of the driving motor 12 drives the fan wheel inside the shell 11 to rotate via a transmission mechanism. Specifically, the output shaft of the driving motor 12 drives a driving shaft to rotate via a pulley transmission structure. The driving shaft is parallel to the output shaft of the driving motor 12 and the driving shaft is connected to the fan wheel in the shell 11. This mounting method and direction of the driving motor 12 reduce the overall size of the fan 10, thereby reducing the space occupied by the fan 10.

The annealing furnace of this embodiment includes a heating chamber and the above heating system. The product to be annealed is placed in the heating chamber. The lower end of the air inlet tube 20 is connected to the air outlet of the heating chamber, and the lower end of the air outlet housing 33 is connected to the air inlet of the heating chamber. The air flow flows from the heating chamber through the fan 10 into the inner housing 31. The heating rods 34 are electrically heated to heat the air flow inside the inner housing 31. The heated air flow returns to the heating chamber through the air outlet housing 33, forming a circulating air flow. The circulating air flow continuously transfers the heat from the heating rods 34 to the product in the heating chamber.

The heating system of this embodiment eliminates the elbow connecting tube, shortening the path of the air flow during transportation and reducing the pressure loss of the air flow at the elbow connecting tube, thereby lowering the system's energy consumption. In conventional heating systems, the presence of the elbow connecting tube is likely to cause turbulence in the air flow, increasing the pressure loss of the air flow and interfering with the air flow speed and direction. However, the present invention, by means of reasonably designing the connection method between the fan 10 and the heater 30, allows the air flow to complete the direction change while maintaining stable flow, thereby effectively reducing pressure loss of the air flow.

In addition, the air inlet end of the fan 10 directly takes in air through the air inlet tube 20, without the need to arrange an elbow connecting tube, further simplifying the structure and reducing pressure loss of the air flow. The heater 30 adopts a cylindrical inner housing 31 structure, and the air flow enters the inner wall of the inner housing 31 in the tangential direction through the tangential air inlet to form a swirling air flow. The swirling air flow can prolong the residence time of the air flow inside the heater 30, increasing the contact area between the air flow and the heating rods 34, thereby further improving the heat exchange efficiency. In addition, the swirling air flow can also suppress the laminar flow phenomenon of hot air to a certain extent, promoting the uniform distribution of hot air within the heater 30, thus further enhancing the heat exchange effect.

This specification and the accompanying drawings are merely exemplary illustrations of this application and are considered to cover any and all modifications, variations, combinations, or equivalents within the scope of this application. It is apparent that those skilled in the art can make various modifications and variations to this application without departing from the scope of this application. Thus, if these modifications and variations of this application fall within the scope of this application and its equivalent technologies, this application intends to include these modifications and variations.

What is claimed is:

1. A heating system, comprising:
a fan, comprising a shell with an air inlet and an air outlet, wherein an air inlet direction of the shell is perpendicular to an air outlet direction of the shell;
an air inlet tube connected to the air inlet of the shell, wherein the air inlet direction of the shell is consistent with an axial direction of the air inlet tube; and
a heater, comprising a cylindrical inner housing, wherein a heating assembly is disposed in the inner housing, a circumferential wall of the inner housing is provided with an air inlet, a first end of the inner housing is closed, a second end of the inner housing is provided with an air outlet, the air outlet of the shell communicates with the air inlet of the inner housing, an air flow output from the shell enters the inner housing in a tangential direction and spirally flows along an inner wall of the inner housing, and is discharged from the air outlet of the inner housing, an air inlet direction of the inner housing is perpendicular to an air outlet direction of the inner housing, and the air inlet direction of the shell is parallel but opposite to the air outlet direction of the inner housing.

2. The heating system according to claim 1, wherein the second end of the inner housing is connected to an air outlet housing, and a diameter of the air outlet housing gradually decreases from an air inlet end to an air outlet end.

3. The heating system according to claim 1, wherein the heating assembly comprises several heating rods, and heating portions of the heating rods are located in the inner housing and extend along an axial direction of the inner housing, such that the air flow maintains contact with the heating rods during spiral flowing within the inner housing.

4. The heating system according to claim 3, wherein the heater further comprises an outer housing, the inner housing is disposed in the outer housing, the outer housing comprises a second end plate, the first end of the inner housing comprises a first end plate, several connecting sleeves are connected between the first end plate and the second end plate to form several through channels between the first end plate and the second end plate, the heating rods are in one-to-one correspondence to the connecting sleeves, each heating rod is fixed to a respective second end plate, and each heating rod runs through a corresponding connecting sleeve to extend into the inner housing.

5. The heating system according to claim 4, wherein the heating rod is fixed with an annular protrusion, the second end plate is located between the first end plate and the annular protrusion, and the second end plate is further provided with a pressing plate configured to press and fix the annular protrusion against an end surface of the second end plate.

6. The heating system according to claim 5, wherein a threaded pillar is disposed on the end surface of the second end plate, the pressing plate movably sleeves the threaded pillar, and a nut is threaded onto the threaded pillar to press and fix the pressing plate against an end surface of the heating rod.

7. The heating system according to claim 1, wherein the fan further comprises a driving motor and a bracket, the bracket is disposed on the shell, the driving motor is disposed on the bracket, an extension direction of an output shaft of the driving motor is parallel to the air inlet direction of the shell, and the output shaft of the driving motor drives a fan wheel in the shell to rotate via a transmission mechanism.

8. An annealing furnace, comprising the heating system according claim 1.

9. An annealing furnace, comprising the heating system according claim 2.
